(19) United States
(12) Patent Application Publication
(10) Pub. No.: US 2002/0184798 A1
(43) Pub. Date: Dec. 12, 2002

(54) Gravesite marker

(76) Inventor: Brenda D. McGovern, Harriman, NY (US)

Correspondence Address: ROGER M. RATHBUN, 13 MARGARITA COURT, HILTON HEAD ISLAND, SC, 29926, US

(21) Appl. No.: 10/165,745

(22) Filed: Jun. 7, 2002

Related U.S. Application Data
(60) Provisional application No. 60/297,280, filed on Jun. 11, 2001.

(51) Int. Cl. G09F 19/00

(52) U.S. Cl. 40/124.5

(57) ABSTRACT

A gravesite marker that can be inserted into the ground to display messages or other indicia to mourners at a gravesite. The marker has a frame with a pointed stake extending therefrom. An opening is formed in the front of the gravesite marker and a receptacle is formed within the gravesite marker where the message is positioned. A slot is also provided for the insertion and removal of the message. In one embodiment, the frame has a front frame member having the stake affixed to or integrally formed therein and a back plate such that the receptacle is formed intermediate those components.

### REFERENCE TO RELATED CASES

The present application is based upon Provisional Patent Application Serial No. 60/297280 filed Jun. 11, 2001 and entitled “GRAVESITE MARKER”.

### BACKGROUND OF THE INVENTION

The present invention relates to a gravesite marker, and, more particularly, to a decorative message holder can be located at a gravesite to convey a message to mourners visiting the grave.

There are, of course, a considerable number of differing gravesite markers and some are intended to hold flowers, some to permanently contain a photograph of the deceased and others even to hold selected memorabilia concerning the deceased and/or the family. For example, in U.S. Pat. No. 4,790,088 of Morvant, there is a photographic marker that provides a permanently mounted photograph and the photograph itself is fused to an aluminum plate and thus the photograph is permanently fixed to the marker. In that patent also, the particular frame containing the photograph is sealed to a permanent grave marker. With the Morvant marker, therefore, the photograph as well as the frame containing that photograph are constructed to be of a permanent nature and there is no means by which that photograph, or any message contained therein, could be changed without a total disassembly of the marker and a reconstruction of the entire grave marker.

In U.S. Pat. No. 5,687,515 of Rodrigues et al, there is a permanent display case that is adapted to contain and display certain objects, however, again, the installation is of a permanent nature as the display case is mounted to a gravestone, albeit detachable, and the actual installation is quite laborious and difficult to construct.

Finally in U.S. Pat. No. 4,631,859 of Letter et al, there is disclosed an integral marker with a flower receptacle and, again, is of a permanent nature and the marker has no provision to add a personalized message to be viewed by mourners visiting the gravesite.

Accordingly, it would be advantageous if there were a gravesite marker that could be installed with minimal effort and yet which could be located in the vicinity of the gravesite and, furthermore, that such marker have a means for persons to leave a message conveying feelings for the deceased to be shared with others visiting the site and that can be easily changed as newer messages or seasonal messages are desired to be displayed.

### SUMMARY OF THE INVENTION

Therefore, in accordance with the present invention, there is provided a gravesite marker that overcomes the deficiencies of the prior art and which provides a marker that can be readily affixed in the immediate vicinity of the gravesite without cumbersome or laborious installation methods or devices. The gravesite marker of the present invention preferably includes a frame, preferably comprised of a cast metal or plastic molded material, and has an inner message receptacle formed in that frame that is accessible to the exterior of the frame by means of a slot and which can be used to slide a message into and out of the frame.

A protective window may be utilized to protect that message from the environmental elements when the message is contained within the message receptacle, however, as will be seen, the message may itself be encased in a protective covering such as being laminated so that a protective window may not be necessary.

The frame preferably has some graphical decoration appropriate to the purpose and which may be of a variety of differing designs as desired by the purchaser of the gravesite marker. The present gravesite marker includes an elongated stake that extends outwardly from the frame and may be an integral part of the frame or may be a separate component that is permanently affixed to the frame. That stake can be driven into the ground to affix the gravesite marker in a desired position and, if needed, can also be relatively easily relocated to another location at the gravesite.

Thus, in accordance with the present invention, a gravesite marker can be provided that is easily affixed in the location of the gravesite without being permanently affixed to the headstone or any other fixture and can, therefore be readily installed by a user, The gravesite marker, as such, has a receptacle within a frame that is open to the external environment by means of a slot that can be accessed from the exterior of that receptacle.

Accordingly, if a mourner desires to leave a personal message at the gravesite, it is a relatively a simple matter to slide the message into the recepticle where that message can be revealed to other mourners that visit the gravesite, however, in the event a new message is desired, it is also a relatively simple matter to remove any one particular message and replace the message with another without the need for disassembly of the gravesite marker to carry out the task.

In the preferred embodiment, the frame is comprised of a front frame member that serves to contain and position the message and the stake is integrally formed along with the front frame member and extends therefrom. The front frame member can be molded of a plastic material or can be comprised of a formed or cast metal material. In the front of the frame, there is located an opening through which the mourner can view the message or other indicia contained within the receptacle that is thus formed between that front frame member and a back plate that is affixed to the rear of the front frame member.

The back plate can be affixed to the front frame member in a variety of manners. The back plate can be fastened to the front frame member by mounting hardware, such as screws, and which method is particularly useful where the frame is constructed of metal, but may be used with plastic construction.

In the event the frame and the back plate are constructed of plastic, the back plate can be ultrasonically welded to the front frame member or solvent bonded to make a permanent bond, or may e snapped into the front frame member in a less permanent arrangement. As a further means of affixing the bvack plate to the front frame member, and particularly useful when the front frame member and the back plate are plastic, preferable polypropylene, there may be a living hinge molded between the front frame member and the back plate such that those components are hingedly secured together and the back plate simply pivoted to a closed, sealed position forming the receptacle and secured in that position by any of a variety of securing means.

Other features of the combination device will become apparent in light of the following detailed description of a preferred embodiment thereof and as illustrated in the accompanying drawings.

### BRIEF DESCRIPTION OF THE DRAWINGS

FIG. 1 is a front view of a gravesite marker constructed in accordance with the present invention;

FIG. 2 is a side cross sectional view of the embodiment of FIG. 1;

FIG. 3 is an enlarged view of a section of Fig.2;

FIG. 4 is a rear view of the present gravesite marker; and

FIG. 5 is a perspective view of the present gravesite marker showing two alternative back plates that can be used therewith.

### DETAILED DESCRIPTION OF THE INVENTION

Referring now to FIG. 1, there is shown a front view of the present gravesite marker 10 and showing the frame 12 and the stake 14 that extends downwardly therefrom. As can be seen, the frame 12 can include any appropriate decoration depending upon the desires of the purchaser and the frame 12 can be constructed of various materials, including formed or cast metal as well as plastics. The material must, however, be sufficiently durable so as to withstand the external environment conditions.

In the preferred embodiment, the frame 12 is comprised of a front frame member 16 and a back plate 18. An opening 20 is formed in the front frame member 16 that is used to actually display a card or other device having indicia thereon which may include a message that one mourner desires to share with other visitors to that gravesite or may even be a picture of drawing that is desired to be so shared.

Again, in the preferred embodiment, the front frame member 16 can be constructed so as to be integral, that is, one piece with the stake 14 extending outwardly from the front frame member 16 with the distal end shaped into a point 22 to facilitate the task of forcing the stake 14 into the ground to affix the gravesite marker 10 in position in the near vicinity of the gravesite. If the frame 12 is plastic, the front frame member 16 and the stake 14 can be molded as one piece and, if metal, the front frame member 16 can be formed or cast as one unitary piece.

There may also be a transparent window (not shown) that covers the opening 20 to protect the message contained therein from the external environment. Thus, the message may be printed on a substance such as paper, cardboard or like deteriorable material in conveying the message to others at the gravesite and be protected from rapid deterioration. The window may be glass or plastic or other material as long as it is transparent and also affords the needed protection to the message contained within the gravesite marker 10. As indicated, the protective window may be eliminated entirely in the event there is some protective cover over the message itself, for example, if the message were laminated and thus be able to withstand the elements without the need for a protective window.

In the preferred embodiment, the inner dimensions of the opening 20 are about 4 inches by 6 inches in order to accommodate various standard cards as well as mailing envelopes and the like while the overall external dimensions of the decorative frame 14 may be about 5 inches by 7 inches.

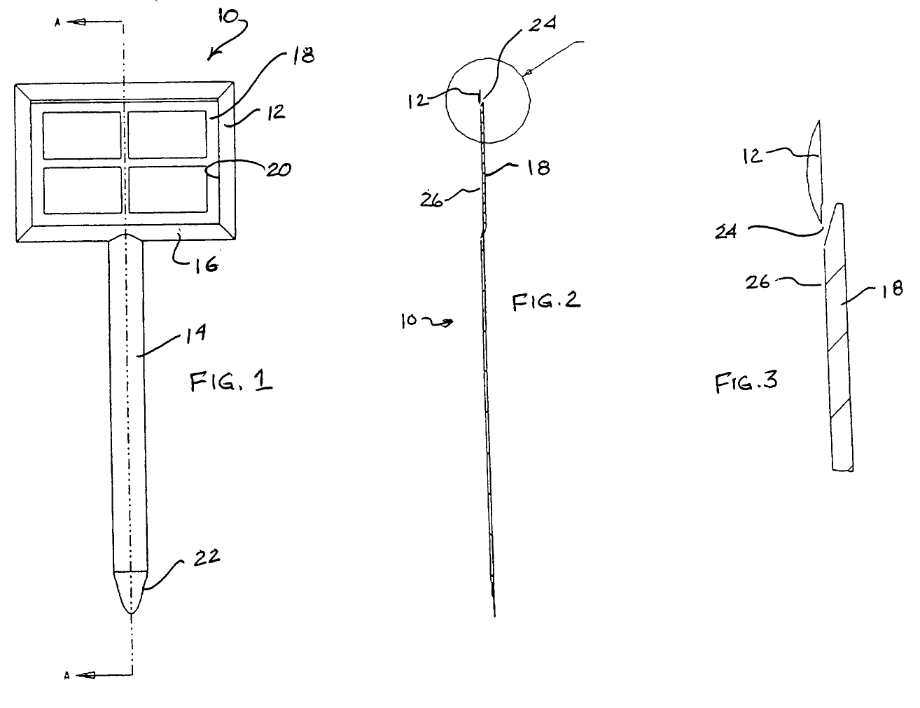

Turning now to FIG. 2, there is shown a side, cross sectional view of the embodiment of FIG. 1 taken along the line A-A of FIG. 1. As can be seen in FIG. 2, the decorative frame 12 is provided with the back plate 18 at the rear of the decorative frame 12. By convention, the front of the gravesite marker 10 will be shown as the surface facing outwardly in FIG. 1 and is the direction the message would be facing if contained within the gravesite marker 10 and viewable through the opening 20. As an alternative to an integral construction of the front frame member 16 with the stake 14, the stake 14 can be permanently affixed, such as by welding, to the decorative frame 12 such that the overall gravesite marker 10 is of a sturdy construction and of a metal material so as to withstand environmental forces.

A slot 24 can be formed in the top of the decorative frame 12 so as to insert the card, letter of other material having the written or drawn indicia setting forth the message to be displayed. As such, by inserting the card into the slot 24, the card is then located within a receptacle 26 of protective space within the frame 12 and is contained therein to be protected from the external environment and yet be visible to the outside through the protective window 18. As shown, the slot 24 is in the top of the graveside marker 10 and in such case the message would preferably be laminated or encased in some enclosure to be protected against the elements. Alternatively, the slot 24 may be located in the side of the gravesite marker 10 and the top covered up so as to protect the message.

In FIG. 3, there is an enlarged view of the top area of the gravesite marker 10 showing the receptacle 26 where the card or other message containing the medium is retained and illustrating the gravesite marker 10 of the present invention. As can be seen in FIG. 3, the slot 24 is formed between the back plate 18 and the frame 12 for insertion of a card or other indicia bearing object into the receptacle 26. The slot can be formed by an elongated angled surface 26 in the back plate 18 along the top thereof of a length sufficient to allow a standard card to be inserted through that slot 24. The remaining peripheral surface of the back plate 18 can fit and abut against the inner surface of the frame 12.

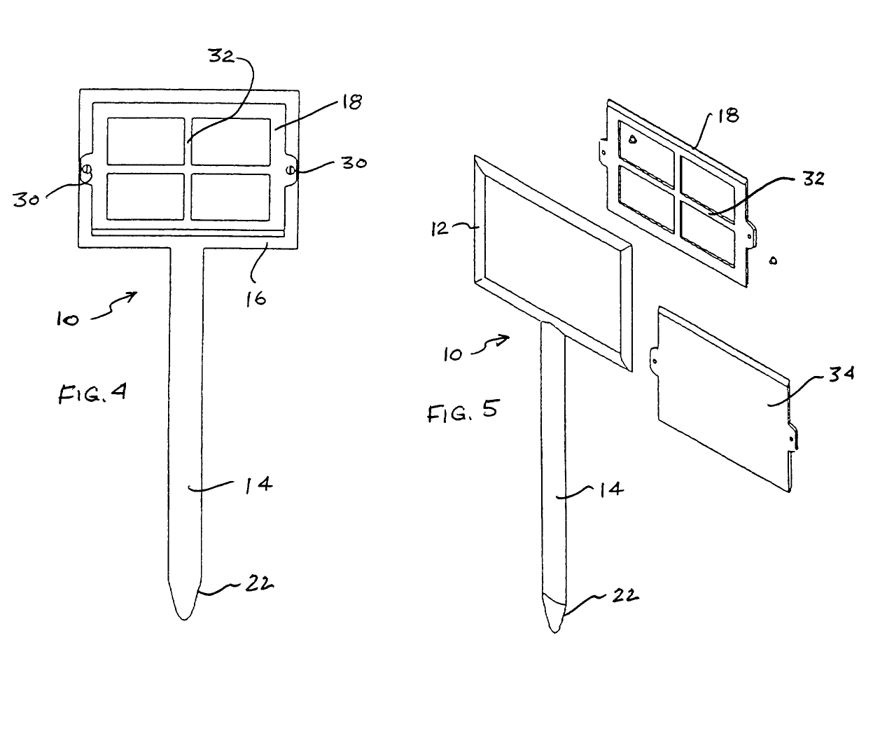

Turning now to FIG. 4, there is shown a rear view of the gravesite marker 10 constructed in accordance with the present invention. In FIG. 4, there can be seen the back plate 18 that, in this embodiment, is affixed to the front frame member 16 by mounting hardware, such as screws 30. The back plate 18 in this Figure has a cross shaped divider 32.

Turning now to FIG. 5, there is shown a front perspective view of the gravesite marker 10 of the present invention and illustrating two different back plates, that is, a back plate 18 having the divider 32 and a solid back plate 34, either of which can be used with the present invention.

While the preferred embodiments have been described and illustrated, various modifications and substitutions may be made without departing from the scope and spirit of this invention. It is to be understood, therefore, that the present invention has been described by way of illustration and not limitation.

I claim:

1. A gravesite marker, said gravesite marker comprising a frame, a stake having a sharpened distal end extending from said frame for driving said stake into the ground to affix said gravesite marker in a desired location, said frame comprising a front surface and a rear surface, said front surface having an opening therein, said frame having an inner receptacle intermediate said front and said rear surfaces and a slot providing access to said inner receptacle from the external environment, said slot adapted to receive a message to position the message within said receptacle so as to be visible from the external environment through said opening.

2. A gravesite marker as defined in claim 1 where said frame comprises a front frame member and wherein said stake is integrally formed with said front frame member.

3. A gravesite marker as defined in claim 2 where said frame further comprises a back plate affixed to said front frame member and positioned opposite said opening and wherein said slot is formed intermediate said front frame member and said back plate.

4. A gravesite marker as defined in claim 3 where said back plate is hingedly affixed to said front frame member.

5. A gravesite marker as defined in claim 4 where said front frame member and said back plate are plastic material and said hinged connection is a living hinge joining said front frame member and said back plate.

6. A gravesite marker as defined in claim 3 where said back plate is affixed to said front frame member by means of mounting hardware.

7. A gravesite marker as described in claim 1 wherein said gravesite marker is generally rectangular having a top, bottom and sides and said slot is located in said top of said graveside marker.

8. A gravesite marker as described in claim 1 wherein said gravesite marker is generally rectangular having a top, bottom and sides and said slot is located in one of said sides of said graveside marker.

9. A gravesite marker as described in claim 1 wherein said frame and said stake are comprised of a cast metal material.

10. A gravesite marker as described in claim 1 wherein said frame is comprised of a molded plastic material.

11. A gravesite marker as described in claim 1 wherein said grave marker includes a transparent window extending across said opening to protect a message located within said receptacle.

12. A gravesite marker, said gravesite marker comprising a frame, a stake having a sharpened distal end extending from said frame for driving said stake into the ground to affix said gravesite marker in a desired location, said frame comprising a front surface and a rear surface, said front surface having an opening therein, said frame having an inner receptacle intermediate said front and said rear surfaces and a slot providing access to said inner receptacle from the external environment, a message located within said receptacle and being removable from said receptacle through said slot, said message being visible from the external environment through said opening.

13. A gravesite marker as defined in claim 12 wherein said message is a cellulose material laminated within a plastic material.

14. A gravesite marker as defined in claim 12 wherein said frame has an exterior surface comprised of a decorative design.

15. A gravesite marker as defined in claim 12 wherein said message is a graphical picture.

16. A gravesite marker as defined in claim 12 wherein said frame comprises a front frame member having said stake extending therefrom and a back plate, and said receptacle is formed between said front frame member and said back plate.

17. A gravesite marker as defined in claim 16 wherein said slot is formed between said front frame member and said back plate.

18. A gravesite marker as defined in claim 12 wherein said slot is located at the top of said frame.
